(19) United States
(12) Patent Application Publication
(10) Pub. No.: US 2013/0163194 A1
(43) Pub. Date: Jun. 27, 2013

(54) CABINET WITH COOLING SYSTEM

(71) Applicants: CHIH-CHUNG SHIH, Tu-Cheng (TW); CHIA-WEN LEE, Tu-Cheng (TW); CHAO-KE WEI, Tu-Cheng (TW); XIAN-XIU TANG, Shenzhen City (CN)

(72) Inventors: CHIH-CHUNG SHIH, Tu-Cheng (TW); CHIA-WEN LEE, Tu-Cheng (TW); CHAO-KE WEI, Tu-Cheng (TW); XIAN-XIU TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/439,867

(22) Filed: Apr. 5, 2012

(30) Foreign Application Priority Data
Dec. 21, 2011 (CN) 201110432403.X

(51) Int. Cl. G06F 1/20

(52) U.S. Cl. 361/679.48

(57) ABSTRACT

A cabinet includes a chassis, a server module, a first cooling module, and a number of second cooling modules. The server module includes servers received in the chassis, and each server includes heat generating components. The first cooling module includes first fans. The second cooling modules are mounted in each server. Each second cooling module includes a second fan and a temperature sensor electrically connected to the second fan. When temperatures measured by the sensors are lower than a predetermined temperature, only the first fans are employed to dissipate heat of the servers; when any of the measured temperatures is higher than the predetermined temperature, the temperature sensor that detected the higher temperature transmits a signal to the corresponding second fan for starting the second fan.

### BACKGROUND

1. Technical Field

The disclosure generally relates to cooling systems, particularly to a cabinet including a cooling system for dissipating heat generated by servers in the cabinet.

2. Description of Related Art

Many electronic components in a server generate heat when operating. In designing a cabinet for containing multiple servers, a number of fans are positioned in the servers for dissipating heat generated by the servers.

However, all the fans are usually the same air output, but each server might produce different amounts of heat. When heat generation is low the same amount of power is used to operate the fans as when there is a lot of heat generated. Therefore, power will be wasted.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary cabinet with cooling system. Moreover, in the drawings, like reference numerals designate corresponding parts throughout the several views. Wherever possible, the same reference numbers are used throughout the drawings to refer to the same or like elements of an embodiment.

FIG. 1 is a schematic view of an embodiment of a cabinet including a cooling system.

FIG. 2 is a block view of the server module in the cabinet in FIG. 1.

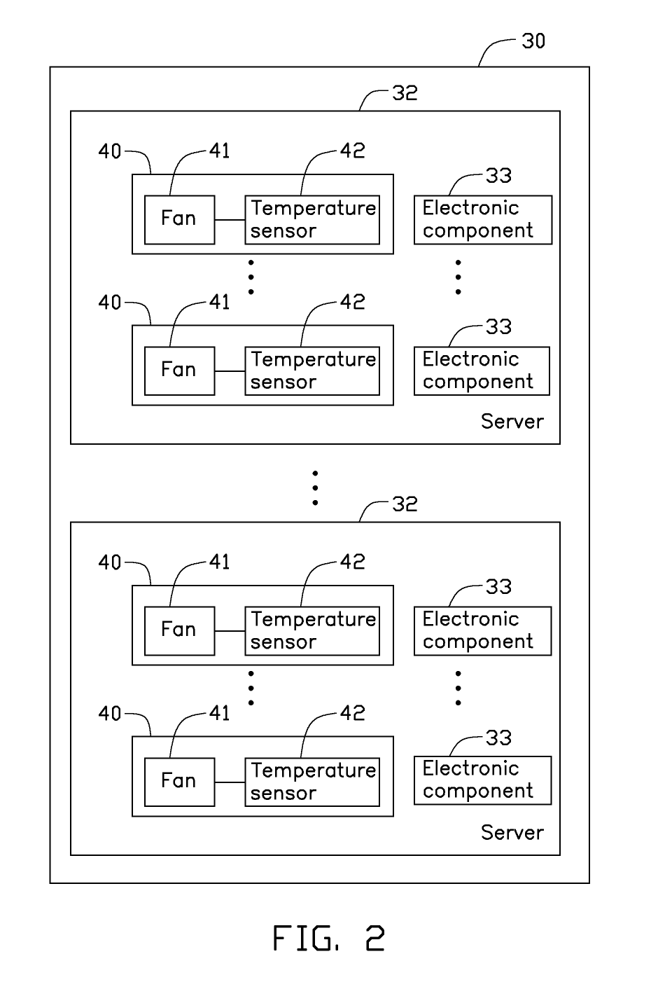

### DETAILED DESCRIPTION

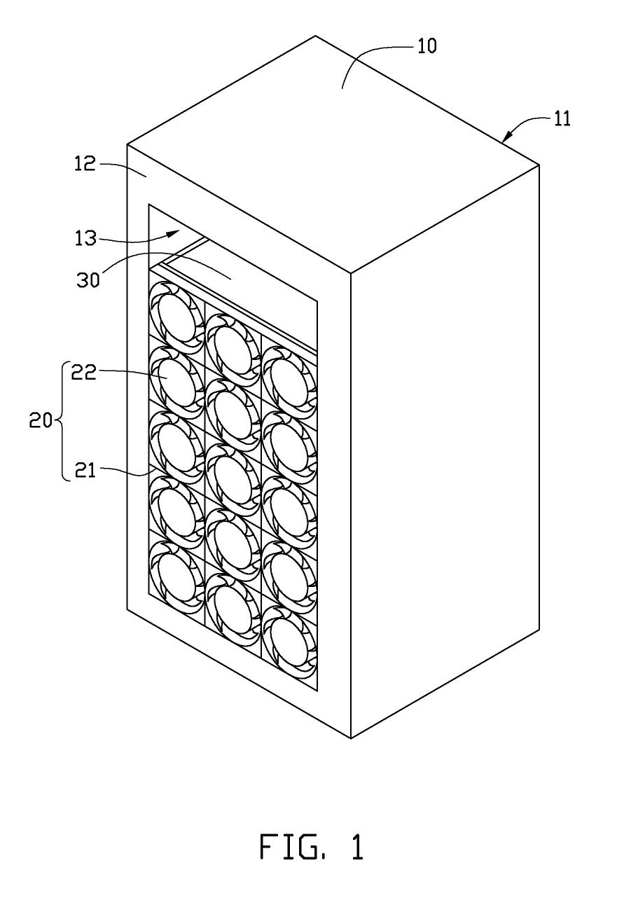

Referring to FIG. 1, a cabinet 100 is used for housing electrical components, such as telecommunication equipment. In this exemplary embodiment, the cabinet 100 includes a chassis 10, a first cooling module 20, a server module 30, and a number of second cooling modules 40.

The chassis 10 includes a first side 11 (e.g. front side) and a second side 12 (e.g. back side) opposite to the first side 11. The chassis 10 defines a receiving chamber 13 communicating with the first side 11 and the second side 12. A number of slidable guides (not shown) are positioned in inner walls of the receiving chamber 13.

The first cooling module 20 is mounted on the second side 12 for dissipating heat generated by the server module 30. The first cooling module 20 includes a frame 21 and a number of first fans 22. The frame 21 is used for holding the first fans 22. The frame 21 is positioned on the second side 12, and is adjacent to the server module 30 in the chassis 10. The first fans 22 are mounted on the frame 21 for dissipating heat. In this exemplary embodiment, the first fans 22 each have the same power consumption and air output, and are arranged in a five by three matrix.

The server module 30 is received in the chassis 10 from the first side 11. In this exemplary embodiment, the server module 30 includes four servers 32. Conventional slidable guides (not shown) allow each server 32 to be easily slid in and out of the module 30. The first fans 22 operate together to dissipate heat generated by the servers 32.

The second cooling modules 40 are used for assisting to dissipate heat in the servers 32. Several second cooling modules 40 are assembled inside each server 32. The number of cooling modules 40 depends on the quantity of heat generating components 33 in the server 32. For example, a cooling module 40 can be installed for each CPU and each power supply in each server 32. Each second cooling module 40 includes a second fan 41 and a temperature sensor 42. The temperature sensor 42 is electronically connected to a control processor of the second fan 41. The temperature sensor 42 can detect a temperature of the corresponding component 33, and transmit a signal to the control processor of the second fan 41 for activating/deactivating the second fan 41.

In use, when the servers 32 are operating, the first cooling module 20 also operates. The first fans 22 of the first cooling module 20 direct air flow to each server 32 for dissipating heat. If temperature sensors 42 detect temperatures of the components 33 are lower than a predetermined temperature value, only the first cooling module 20 will operate and the second cooling modules 40 will remain off. If the temperature sensors 42 detect that the temperatures of the components 33 are at or above the predetermined temperature, the detecting temperature sensor/s 42 will transmit a signal to the corresponding control processor's of the second fans 41 for starting the second fan 41. Thus, the second fans 41 assist to dissipate heat for the overheating electronic components. With two levels of heat dissipation, power will not be wasted because the second modules 40 will only be brought online as needed for excess heat generation by components 33.

It is to be understood, however, that even through numerous characteristics and advantages of the disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A cabinet comprising:
a chassis;
a server module including a plurality of servers received in the chassis, each server including a plurality of electronic components;
a first cooling module including a plurality of first fans mounted to the chassis;
a plurality of second cooling module mounted inside each server; each second cooling module including a second fan and a temperature sensor electrically connected to the second fan;
wherein each temperature sensor detects the temperature of its respective electronic component, when the temperature sensor detects that the temperature of each electronic component in each server is lower than a predetermined temperature value, the first fans of the first cooling module work for dissipating heat of the servers; when the sensor detects that the temperature of any of the electronic components inside each server is higher than the predetermined temperature value, the temperature sensor transmits a signal to the second fan for starting the second fan.

2. The cabinet as claimed in claim 1, wherein the chassis includes a first side and a second side opposite to the first side, and the chassis defines a receiving chamber communicating with the first side and the second side, the servers are received in the chassis from the first side, and the first fans are mounted on a second side adjacent to the servers.

3. The cabinet as claimed in claim 2, wherein the first cooling module includes a frame, the frame is positioned on the second side, and the first fans are mounted on the frame for dissipating heat.

4. A cabinet comprising:
a chassis;
a plurality of servers received in the chassis;
a plurality of first fans mounted in one side of the chassis;
a plurality of second fans and temperature sensors mounted inside each server; each second fan electrically connected to a respective temperature sensor;
wherein the temperature sensors detect the temperature inside of each server, when the detected temperature of each server is lower than a predetermined temperature value, the first fans work for dissipating heat of the servers; when the detected temperature of any server is higher than the predetermined temperature value, the temperature sensors transmit a signal to the second fans for starting the second fans.

5. The cabinet as claimed in claim 4, wherein the chassis includes a first side and a second side opposite to the first side, and the chassis defines a receiving chamber communicating with the first side and the second side, the servers are received in the chassis from the first side, and the first fans are mounted on a second side adjacent to the servers.

6. The cabinet as claimed in claim 5, further comprising a frame, wherein the frame is positioned on the second side, and the first fans are mounted on the frame for dissipating heat.
